(19) United States
(12) Patent Application Publication
(10) Pub. No.: US 2023/0007073 A1
(43) Pub. Date: Jan. 5, 2023

(54) TRANSFERRING FILES IN ACCORDANCE WITH A DATA COMMUNICATIONS PROTOCOL

(71) Applicant: LENOVO (UNITED STATES) INC., MORRISVILLE, NC (US)

(72) Inventors: BOGDAN-ALEXANDRU RATIU, SEGOVIA (ES); GAVRIL IOAN FLORIAN, CHITILA (RO); CORNELIU-ILIE CALCIU, BUCHAREST (RO); RADU MIHAI IORGA, BUCHAREST (RO)

(21) Appl. No.: 17/364,358

(22) Filed: Jun. 30, 2021

(51) Int. Cl. H04L 29/08; G06F 16/13; H04L 29/06

(52) U.S. Cl. CPC H04L 67/06; G06F 16/137; H04L 67/42

(57) ABSTRACT

Transferring files in accordance with a data communications protocol includes: receiving, by a server from a client, a read request for a file, where the read request specifies a filename of the file, a message digest algorithm, and a key, where the key includes a result of applying the message digest algorithm to the file as stored on the client; generating, by the server, a local key including applying the message digest algorithm to a file currently stored on the server and having the filename; and if the local key matches the key specified in the read request, closing, by the server, a connection to the client with success without sending the requested file.

### BACKGROUND

### Field of the Disclosure

The field of the disclosure is data processing, or, more specifically, methods, apparatus, and products for transferring files in accordance with a data communications protocol.

### Description of Related Art

Communication protocols are systems of rules that allow two or more entities of a communications system to transmit information between one another. The communication protocol defines the rules, syntax, semantics and synchronization of communication and possible error recovery methods. Communication protocols may be implemented by hardware, software, or a combination of both. Data communication protocols are often used to allow a client to retrieve a file from or place a file onto a host. Often, clients may receive duplicates of files that are already presently stored on the client.

### SUMMARY

Methods for transferring files in accordance with a data communications protocol are disclosed in this specification. In accordance with one aspect of the present disclosure, such transferring may include: receiving, by a server from a client, a read request for a file, wherein the read request specifies a filename of the file, a message digest algorithm, and a key, wherein the key comprises a result of applying the message digest algorithm to the file as stored on the client; generating, by the server, a local key including applying the message digest algorithm to a file currently stored on the server and having the filename; and if the local key matches the key specified in the read request, closing, by the server, a connection to the client with success without sending the requested file.

In accordance with another aspect of the present disclosure, a method of transferring files in accordance with a data communications protocol includes: receiving, by a server from a client, a write request for a file, wherein the write request specifies a filename of the file, a message digest algorithm, and a key, wherein the key comprises a result of applying the message digest algorithm to the file as stored on the client; generating, by the server, a local key including applying the message digest algorithm to a file currently stored on the server and having the filename; and if the local key matches the key specified in the write request, prematurely terminating, by the server, a data communications connection with the client, thereby prohibiting the file to be transmitted from the client to the server.

In accordance with another aspect of the present disclosure, a method of transferring files in accordance with a data communications protocol includes: sending, by a client to a server, a write request for a file, wherein the write request specifies a filename of the file, and a message digest algorithm; receiving, by the client from the server, a key, wherein the key comprises a result of applying the message digest algorithm to a file currently stored on the server and having the filename; generating, by the client, a local key including applying the message digest algorithm to the file as stored on the client; and if the local key matches the key received from the server, closing, by the client, a connection to the server with success without sending the requested file.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 shows an example line drawing of a client and a server configured for transferring files in accordance with a data communications protocol in accordance with embodiments of the present disclosure.

FIG. 2 shows a block diagram of an example initial packet for transfer in accordance with a data communications protocol in accordance with embodiments of the present disclosure.

FIG. 3 is a flowchart of an example method for transferring files in accordance with a data communications protocol according to some embodiments of the present disclosure.

FIG. 4 is a flowchart of an example method for transferring files in accordance with a data communications protocol according to some embodiments of the present disclosure.

FIG. 5 is a flowchart of an example method for transferring files in accordance with a data communications protocol according to some embodiments of the present disclosure.

### DETAILED DESCRIPTION

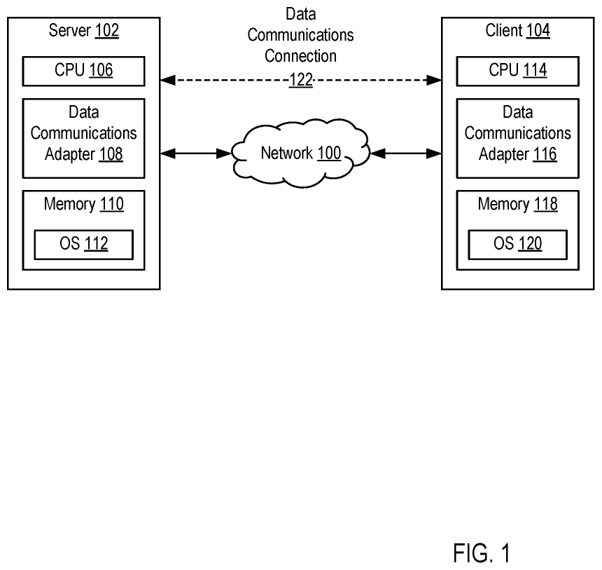

Exemplary methods, apparatus, and products for transferring files in accordance with a data communications protocol in accordance with the present disclosure are described with reference to the accompanying drawings, beginning with FIG. 1. FIG. 1 sets forth an example line drawing of a client and a server configured for transferring files in accordance with a data communications protocol according to embodiments of the present disclosure. The example system of FIG. 1 includes a client 104 connected to a server 102 through a network 100.

The example server 102 of FIG. 1 includes a central processing unit (CPU′) 106, a data communications adapter 108, and memory 110. Stored in memory 110 of the server is an operating system 112. The example client 104 includes a CPU 114, a data communications adapter 116, and memory 118. Stored in memory 118 of the client is an operating system 120. Both the server 102 and the client 104 are configured for transferring files in accordance with a data communications protocol using a data communications connection 122. Examples of data communications protocols may include Trivial File Transfer Protocol (‘TFTP’), File Transfer Protocol (‘FTP’), and the like.

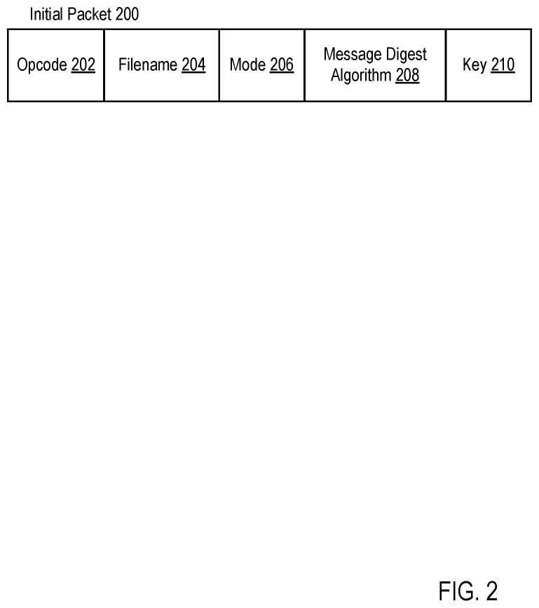

In the example system of FIG. 1, the client may be configured to send a read request or a write request to the server using the data communications connection 122. A read request and a write request may be sent using the data communications connection in the form of a packet, referred to in this specification as an initial packet such as the one depicted in FIG. 2 and described below in greater detail. In response to receiving the request, the server may respond by sending an acknowledgement packet to the client. The acknowledgement packet may include an indication of readiness to receive the file from the client for a write request, or the acknowledgment packet may include the file being requested for a read request.

In some embodiments a file having the same filename as the file specified in the initial packet may or may not be stored on the recipient. That is, in one example, a server may receive a read request from a client requesting a file from the server that is already stored on the client. In this way, the client may request, from the server, an updated version of the file already stored on the client. In such cases where the requested file is already current and updated on the client, the server may send, in response to the read request, a duplicate of the file already stored on the client. In such cases, the read request may be unnecessarily performed and result in an unnecessary utilization of bandwidth for carrying out the unneeded file transfer.

In another example, the server may receive a write request from a client requesting to send the server a file that is already stored on the server. In this way, the client may request to send, to the server, an updated version of the file already stored on the server. In such cases where the requested file is already current and updated on the server, the server may receive, in response to the write request, a duplicate of the file already stored on the server. In such cases, the write request may be unnecessarily performed and result in an unnecessary utilization of bandwidth for carrying out the unneeded file transfer.

For further explanation, FIG. 2 sets forth a block diagram of an example initial packet 200 for transfer in accordance with a data communications protocol in accordance with embodiments of the present disclosure. The initial packet 200 includes an opcode 202, a filename 204, a mode 206, a message digest algorithm 208, and a key 210. The initial packet 200 may be sent by the client to the server, or by the server to the client, in order to initiate the start of the data communications connection 122. Those skilled in the art will recognize that data communications protocol packets, such as TFTP, may be configured with options. According to embodiments of the present disclosure, the message digest algorithm 208 and the key 210 of FIG. 2 may be included within the initial packet as such options.

The opcode 202 is a field within the initial packet that specifies either a read request or a write request. The filename 204 is a field within the initial packet that specifies name of the file requested to be read or written. The mode 206 is a field within the initial packet that specifies the mode of file transfer. Examples of the mode of file transfer include netascii, octet, and mail.

The message digest algorithm 208 is a field within the initial packet that specifies a message digest algorithm to be applied to the file specified in the initial packet. A message digest algorithm is a function that maps data of an arbitrary size to fixed size values. Examples of message digest algorithms include md5sum, sha256sum, and sha512sum, among others. For example, a client that sends an initial packet to a server may use the message digest algorithm 208 field to specify a message digest algorithm of md5sum to be applied to the file. If the server receiving the initial packet does not support the message digest algorithm specified in the message digest algorithm 208 field, the server may ignore the option, as well as the key 210 field option, and proceed with the read or write request according to the data communications protocol.

As mentioned above, if a recipient of an initial packet does not support a message digest algorithm or, more generally, the option that relies on message digest algorithms, the recipient may ignore the option and process the initial packet in accordance with the standard data communications protocol. TFTP, for example, provides for various options to extend the data communications protocol capability. If one of the parties in a TFTP data communications connection does not support a particular option, that party can continue communicating according to the standard TFTP (as extended by any options that the party does support), without failing or otherwise raising an error. In accordance with embodiments of the present disclosure, an option is implemented that provides for reducing redundant file transfers through use of message digest algorithms. In this way, if a recipient of an initial packet does not support the option for reducing redundant file transfers according to embodiments of the present disclosure, the recipient may process the data communications without using the option.

The key 210 is a field within the initial packet that includes a result of the message digest algorithm used. The key 210 may include the result, or hash, of the message digest algorithm used on a file with the filename 204 included within the packet 200. The key may also contain a value of zero, indicating that the message digest algorithm has not been used.

Readers of skill in the art will recognize that while the packet of FIG. 2 is an example of an initial packet sent using the data communications connection and according to a data communications protocol, other packets containing different values or options may be sent between the client and the server during the life of the data communications connection. Example packets may include acknowledgement packets with the message digest algorithm 208 and the key 210 set to a value of zero or not specified at all.

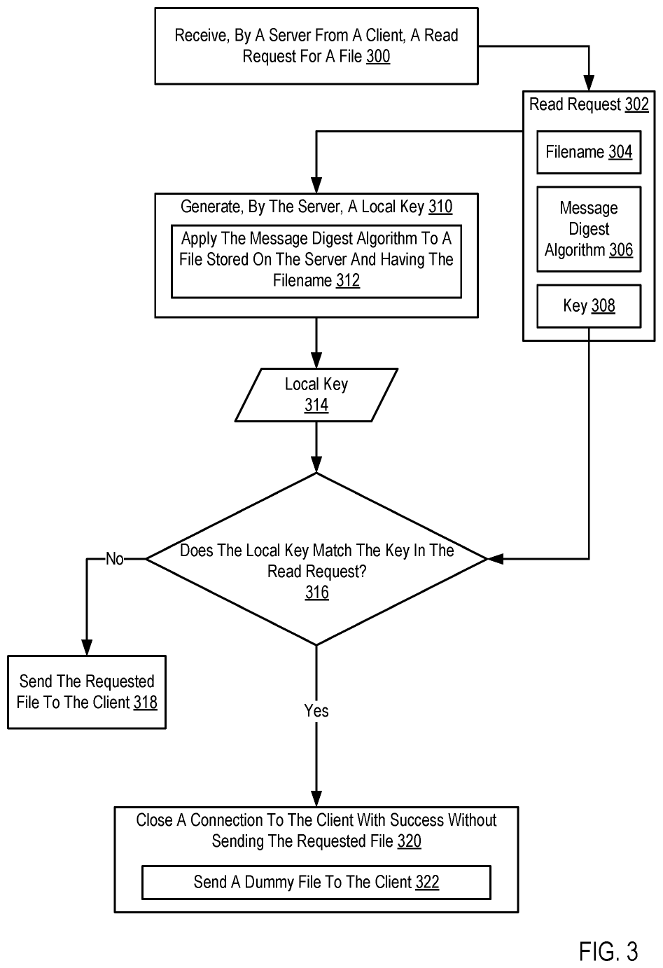

For further explanation, FIG. 3 sets forth a flow chart illustrating an exemplary method for transferring files in accordance with a data communications protocol according to embodiments of the present disclosure. The method of FIG. 3 includes receiving 300, by a server 102 from a client 104, a read request 302 for a file. In the method of FIG. 3, the read request specifies a filename 304 of the file, a message digest algorithm 306, and a key 308. The key 308 is a result of applying the message digest algorithm to the file as stored on the client, such as, for example, a hash. The key 308 may be a result of applying the message digest algorithm 306 to a file currently stored on the client and having the filename 304 specified in the read request 302. For example, the key 308 includes the hash of the contents of the file currently stored on the client and having the filename 304 specified in the read request 302. Receiving 300, by the server from the client, the read request 302 for a file may be carried out by receiving an initial packet 200 from the client using a data communications connection 122, where the header of the initial packet includes an opcode value specifying the request as a read request.

As an example, consider that the server receives an initial packet from the client. The initial packet includes a header with fields similar to those in the example packet of FIG. 2. The initial packet may, for example, include an opcode value specifying the initial packet as a read request, a filename field specifying the name of a file to be read from the server as “config.txt,” a message digest algorithm of md5sum, and a key value of 8743b52063cd84097a65d1633f5c74f5.

The method of FIG. 3 also includes generating 310, by the server 102, a local key 314. In the method of FIG. 3, generating 310 the local key 314 includes applying 312 the message digest algorithm 306 to a file currently stored on the server and having the filename 304 specified in the read request 302. The local key 314 may be a result of applying 312 the message digest algorithm 306 to a file currently stored on the server and having the filename 304 specified in the read request 302. For example, the local key 314 includes the hash of the contents of the file currently stored on the server and having the filename 304 specified in the read request 302.

Continuing with the example above, the server may generate a local key by applying the md5sum message digest algorithm to a file stored on the server named “config.txt”. The local key generated may be a hash of the config.txt and result in a value of 8743b52063cd84097a65d1633f5c74f5.

The method of FIG. 3 also includes determining 316 whether the local key 314 matches the key 308 specified in the read request 302. Determining 316 whether the local key 314 matches the key 308 specified in the read request 302 may be carried out by comparing, by the server, the local key 314 with the key 308 specified in the received read request 302.

If the local key 314 matches the key 308 specified in the read request 302, the method of FIG. 3 continues by closing 320, by the server 102, a connection 122 to the client 104 with success without sending the requested file to the client. Closing 320, by the server 102, a connection 122 to the client 104 with success without sending the requested file to the client may be carried out by sending 322 a dummy file to the client 104. Sending 322 a dummy file to the client 104 may be carried out by the server sending a file or packet to the client that represents that the local key 314 matches the key 308 specified in the read request 302. The dummy file sent to the client may be a file that includes predefined content such as well-known code that indicates to the requestor a matching key. The dummy file may also be a file with a file size of zero. In this way, the server may send a dummy file to the client, and therefore avoid an unneeded transfer of a duplicate file, in response to determining that the contents of the requested file currently stored on the server match the contents of the requested file currently stored on the client.

Continuing with the example above, the local key of 8743b52063cd84097a65d1633f5c74f5 matches the key 8743b52063cd84097a65d1633f5c74f5 in the initial packet. As such, the server, rather than transmitting the config.txt file to the requesting client, may instead send a dummy file of size 0 to indicate that the client is in possession of the same version of the config.txt file stored on the server. In this way, the server may reduce the utilization of bandwidth and other data communications resources that would otherwise be required to transfer the config.txt file to the client.

If the local key 314 does not match the key 308 specified in the read request 302, the method of FIG. 3 continues by sending 318, by the server, the requested file to the client. Sending 318, by the server, the requested file to the client may be carried out by sending packets of data forming the requested file over the data communications connection between the client and server and in accordance with the standard data communications protocol.

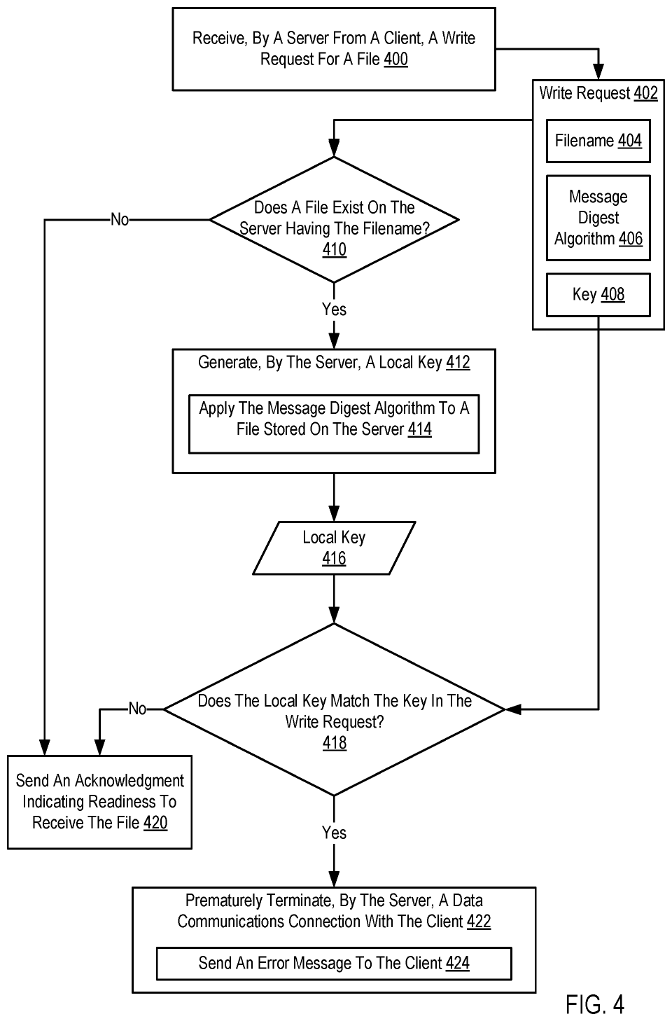

For further explanation, FIG. 4 sets forth a flow chart illustrating a further exemplary method for transferring files in accordance with a data communications protocol according to embodiments of the present disclosure. The method of FIG. 4 includes receiving 400, by a server 102 from a client 104, a write request 402 for a file. In the method of FIG. 4, the write request specifies a filename 404 of the file, a message digest algorithm 406, and a key 408. The key 408 is a result of applying the message digest algorithm 406 to the file as stored on the client, such as, for example, a hash. The key 408 includes a result of applying the message digest algorithm 406 to a file currently stored on the client and having the filename 404 specified in the write request 402. For example, the key 408 includes the digest of the contents of the file currently stored on the client and having the filename 404 specified in the write request 402. Receiving 400, by a server from a client, the write request 402 for a file may be carried out by receiving an initial packet 200 from the client using a data communications connection 122, where the header of the initial packet includes an opcode value specifying the request as a write request.

As an example, consider that the server receives an initial packet from the client. The initial packet includes a header with fields similar to those in the example packet of FIG. 2. The initial packet may, for example, include an opcode value specifying the initial packet as a write request, a filename field specifying the name of a file to be written to the server as “config.txt,” a message digest algorithm of md5sum, and a key value of 8743b52063cd84097a65d1633f5c74f5.

The method of FIG. 4 also includes determining 410, by the server, whether a file exists on the server 102 having the filename 404 specified in the write request 402. Determining 410, by the server, whether a file exists on the server 102 having the filename 404 specified in the write request 402 may be carried out by the server comparing filename 404 specified in the write request with the filenames of all the files stored within the memory of the server.

The method of FIG. 4 also includes generating 412, by the server 102, a local key 416. In the method of FIG. 4, generating 412 the local key 416 includes applying 414 the message digest algorithm 406 to a file currently stored on the server 102 and having the filename 404 specified in the write request 402. Generating 412, by the server 102, a local key 416 may be carried out only if the server determines that a file exists on the server 102 having the filename 404 specified in the write request 402. If the server determines that a file does not exist on the server having the filename specified in the write request, the server may send an acknowledgment indicating readiness to receive the file from the client. The acknowledgment packet sent to the client may include zero or null values in the key field and the message digest algorithm field. The local key 416 may be a result of applying 414 the message digest algorithm 406 to a file currently stored on the server and having the filename 404 specified in the write request 402. For example, the local key 416 includes the hash of the contents of the file currently stored on the server and having the filename 404 specified in the write request 402.

Continuing with the example above, the server may generate a local key by applying the md5sum message digest algorithm to a file stored on the server named “config.txt”. The local key generated may be a hash of the config.txt and result in a value of 8743b52063cd84097a65d1633f5c74f5.

The method of FIG. 4 also includes determining 418 whether the local key 416 matches the key 408 specified in the write request 402. Determining 418 whether the local key 416 matches the key 408 specified in the write request 402 may be carried out by comparing, by the server, the local key 416 with the key 408 specified in the received write request 402.

If the local key 416 matches the key 408 specified in the write request 402, the method of FIG. 4 continues by prematurely terminating 422, by the server, a data communications connection 122 with the client 104, thereby prohibiting the file to be transmitted from the client to the server. Prematurely terminating 422, by the server, a data communications connection 122 with the client 104 may be carried out by sending 424 an error message to the client 104. Sending 424 an error message to the client 104 may be carried out by the server sending an error message to the client in order to prohibit the file from being transmitted from the client to the server. In this way, the server may prohibit the requested file from being transferred from the client, and therefore prohibit an unneeded transfer of a duplicate file, in response to determining that the contents of the requested file currently stored on the server match the contents of the requested file currently stored on the client.

Continuing with the example above, the local key of 8743b52063cd84097a65d1633f5c74f5 matches the key 8743b52063cd84097a65d1633f5c74f5 in the initial packet. As such, the server, rather than receiving the config.txt file from the requesting client, may instead prematurely terminate the data communications connection between the client and the server. In this way, the server may reduce the utilization of bandwidth and other data communications resources that would otherwise be required to for the client to transfer the config.txt file to the server.

If the local key 416 does not match the key 408 specified in the write request 402, the method of FIG. 4 continues by sending 420, by the server, an acknowledgment indicating readiness to receive the file from the client. Sending 420, by the server, an acknowledgment indicating readiness to receive the file from the client may be carried out by sending an acknowledgment packet over the data communications connection between the client and the server and in accordance with the standard data communications protocol.

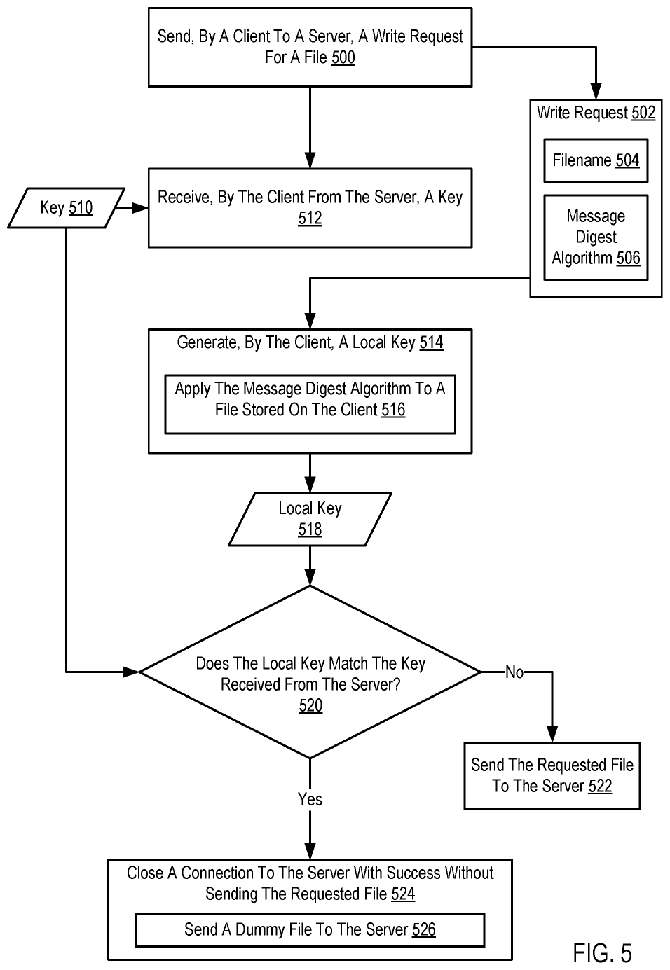

For further explanation, FIG. 5 sets forth a flow chart illustrating a further exemplary method for transferring files in accordance with a data communications protocol according to embodiments of the present disclosure. The method of FIG. 5 includes sending 500, by a client 104 to a server 102, a write request 502 for a file. In the method of FIG. 5, the write request 502 specifies a filename 504 of the file, and a message digest algorithm 506. Sending 500, by a client 104 to a server 102, a write request 502 for a file may be carried out by the client sending an initial packet 200 to the server using a data communications connection 122, where the header of the initial packet includes an opcode value specifying the request as a write request.

As an example, consider that the client sends an initial packet to the server. The initial packet includes a header with fields similar to those in the example packet of FIG. 2. The initial packet may, for example, include an opcode value specifying the initial packet as a write request, a filename field specifying the name of a file to be written to the server as “config.txt,” and a message digest algorithm of md5sum.

The method of FIG. 5 also includes receiving 512, by the client 104 from the server 102, a key 510. The key 510 is a result of applying the message digest algorithm 506 to a file currently stored on the server and having the filename 504 specified in the write request 502. For example, the key 510 includes the hash of the contents of the file currently stored on the server and having the filename 504 specified in the write request 502.

Continuing with the example above, the client may receive a packet from the server that includes a key value of 8743b52063cd84097a65d1633f5c74f5. The key in this example is a value resulting from applying a mda5sum hashing algorithm to the config.txt file stored on the server.

The method of FIG. 5 also includes generating 514, by the client 104, a local key 518. In the method of FIG. 5, generating 514 the local key 518 includes applying 516 the message digest algorithm 506 to the file as stored on the client and having the filename 404 specified in the write request 502. For example, the local key 518 includes the hash of the contents of the file with the filename 504 as currently stored on the client.

Continuing with the example above, the client may generate a local key by applying the md5sum message digest algorithm to a file stored on the server named “config.txt”. The local key generated may be a hash of the config.txt and result in a value of 8743b52063cd84097a65d1633f5c74f5.

The method of FIG. 5 also includes determining 520 whether the local key 518 matches the key 510 received from the server 102. Determining 520 whether the local key 518 matches the key 510 received from the server 102 may be carried out by comparing, by the client, the local key 518 with the key 510 received from the server 102.

If the local key 518 matches the key 510 received from the server 102, the method of FIG. 5 continues by closing 524, by the client 104, a connection 122 to the server with success without sending the requested file. Closing 524, by the client 104, a connection 122 to the server with success without sending the requested file may be carried out by sending 526 a dummy file to the server 102. Sending 526 a dummy file to the client 104 may be carried out by the client sending a file or packet to the server that represents that the local key 518 matches the key 510 received from the server. The dummy file sent to the server may be a file that includes predefined content such as well-known code that indicates to the requestor a matching key. The dummy file may also be a file with a file size of zero. In this way, the client may send a dummy file to the server, and therefore avoid an unneeded transfer of a duplicate file, in response to determining that the contents of the requested file currently stored on the client match the contents of the requested file currently stored on the server.

Continuing with the example above, the local key of 8743b52063cd84097a65d1633f5c74f5 matches the key 8743b52063cd84097a65d1633f5c74f5 received from the server. As such, the client, rather than transmitting the config.txt file to the server, may instead send a dummy file of size 0 to indicate that the server is in possession of the same version of the config.txt file stored on the client. In this way, the client may reduce the utilization of bandwidth and other data communications resources that would otherwise be required to transfer the config.txt file to the server.

If the local key 518 does not match the key 510 received from the server, the method of FIG. 5 continues by sending 522, by the client, the requested file to the server. Sending 522, by the server, the requested file to the server may be carried out by sending packets of data forming the requested file over the data communications connection between the client and server and in accordance with the standard data communications protocol.

In view of the explanations set forth above, readers will recognize that the benefits of transferring files in accordance with a data communications protocol according to embodiments of the present disclosure include:
Improved computing efficiency when transferring files in accordance with a data communications protocol due to skipping unnecessary downloads.
Improved methods for increasing the speed of some processes, such as boot processes including scripts that require the latest version of a file from a different location.
Improved methods of transferring files in accordance with a data communications protocol by allowing a device to keep the same filenames when downloading a file, and only overwriting the file when a new version appears. Such a device requesting a file download may only receive the file if the contents of the file are different from the currently installed image.

Exemplary embodiments of the present disclosure are described largely in the context of a fully functional computer system for transferring files in accordance with a data communications protocol. Readers of skill in the art will recognize, however, that the present disclosure also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

1. A method of transferring files in accordance with a data communications protocol, the method comprising:
receiving, by a server from a client, a read request for a file, wherein the read request specifies a filename of the file and a key, wherein the key comprises a result of applying a message digest algorithm to the file as stored on the client;
comparing, by the server, the key specified in the read request to a local key wherein the local key comprises a result of applying the message digest algorithm to a file currently stored on the server and having the filename; and
if the local key matches the key specified in the read request, closing, by the server, a connection to the client with success without sending the requested file.

2. The method of claim 1, further comprising:
if the local key does not match the key specified in the read request, sending, by the server, the requested file to the client.

3. The method of claim 1, wherein closing the connection with success without sending the requested file comprises sending, by the server, a dummy file to the client.

4. The method of claim 1, wherein the read request further specifies the message digest algorithm, and wherein local key is generated by the server based on the received read request.

5. The method of claim 4, wherein a type of digest algorithm identified by the message digest algorithm consists of one of: md5sum, sha256sum, and sha512sum.

6. The method of claim 4, wherein the message digest algorithm and the key specified in the read request are data communication protocol options; and
if the server is not configured to support the options specified in the read request, ignoring, by the server, the options.

7. A method of transferring files in accordance with a data communications protocol, the method comprising:
receiving, by a server from a client, a write request for a file, wherein the write request specifies a filename of the file, a message digest algorithm, and a key, wherein the key comprises a result of applying the message digest algorithm to the file as stored on the client;
generating, by the server and based on the received write request, a local key including applying the message digest algorithm to a file currently stored on the server and having the filename; and
if the local key matches the key specified in the write request, prematurely terminating, by the server, a data communications connection with the client, thereby prohibiting the file to be transmitted from the client to the server.

8. The method of claim 7 further comprising:
if the local key does not match the key specified in the write request, sending, by the server to the client, an acknowledgment indicating readiness to receive the file.

9. The method of claim 7, wherein prematurely terminating the data communications connection with the client further comprises sending an error message to the client.

10. The method of claim 7 further comprising:
determining, by the server, whether a file exists on the server having the filename; and
generating the local key only if the file exists on the server.

11. The method of claim 10 further comprising sending, by the server, an acknowledgment to receive the file from the client only if the file does not exist on the server.

12. The method of claim 7, wherein the data communications protocol comprises a Trivial File Transfer Protocol (TFTP).

13. The method of claim 7, wherein a type of digest algorithm identified by the message digest algorithm consists of one of: md5sum, sha256sum, and sha512sum.

14. The method of claim 7, wherein the message digest algorithm and the key specified in the write request are data communication protocol options; and
if the server is not configured to support the options specified in the write request, ignoring, by the server, the options.

15. A method of transferring files in accordance with a data communications protocol, the method comprising:
sending, by a client to a server, a write request for a file, wherein the write request specifies a filename of the file, and a message digest algorithm;
receiving, by the client from the server and based on the write request, a key, wherein the key comprises a result of applying the message digest algorithm to a file currently stored on the server and having the filename;
generating, by the client, a local key including applying the message digest algorithm to the file as stored on the client; and
if the local key matches the key received from the server, closing, by the client, a connection to the server with success without sending the requested file.

16. The method of claim 15, further comprising:
if the local key does not match the key received from the server, sending, by the client, the requested file to the server.

17. The method of claim 15, wherein closing the connection with success without sending the file identified in the write request comprises sending, by the client, a dummy file to the server.

18. The method of claim 15, wherein the data communications protocol comprises a Trivial File Transfer Protocol (TFTP).

19. The method of claim 15, wherein a type of digest algorithm identified by the message digest algorithm consists of one of: md5sum, sha256sum, and sha512sum.

20. The method of claim 15, wherein the message digest algorithm and the key specified in the write request are data communication protocol options; and
if the server is not configured to support the options specified in the write request, ignoring, by the server, the options.
